(19) United States
(12) Patent Application Publication
(10) Pub. No.: US 2006/0223594 A1
(43) Pub. Date: Oct. 5, 2006

(54) Mobile phones

(75) Inventors: Chun-Po Chen, Kaohsiung County (TW); Yen-Chih Lin, Taipei City (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/388,287

(22) Filed: Mar. 24, 2006

(30) Foreign Application Priority Data
Mar. 30, 2005 (TW) 94109984

(51) Int. Cl. H04M 1/00

(52) U.S. Cl. 455/575.2

(57) ABSTRACT

Mobile phones. A mobile phone includes a main body and a hands-free headset detachably connected to the main body. The hands-free headset has a receiver and a microphone. When the hands-free headset and the main body are connected, the receiver and the microphone are received in the main body, and the hands-free headset communicates voice signals to the main body via the receiver and the microphone.

### BACKGROUND

The invention relates in general to mobile phones and in particular to mobile phones with hands-free headsets.

Referring to FIG. 1, a conventional mobile phone primarily includes a main body 10 and a hands-free headset accessory 20. A receiver 101 and a microphone 102 are embedded in the main body 10 for voice communication.

When using the hands-free headset 20, such as an in-ear headphone with the plug 203 joined in the connector 103, the user puts the earphone 201 in the ear and talks via the microphone 202 of the hands-free headset 20 without holding the main body 10. As the conventional hands-free headset 20 serves as an accessory having the same functions of the embedded receiver 101 and the microphone 102 built in the main body 10, however, it occupies more space and inevitably increases production costs.

### SUMMARY

Mobile phones are provided. An exemplary embodiment of a mobile phone includes a main body and a hands-free headset detachably connected to the main body. The hands-free headset has a receiver and a microphone. When the hands-free headset and the main body are connected, the receiver and the microphone are received in the main body, and the hands-free headset communicates voice signals to the main body via the receiver and the microphone.

### DESCRIPTION OF THE DRAWINGS

FIG. 1 is a perspective diagram of a conventional mobile phone;

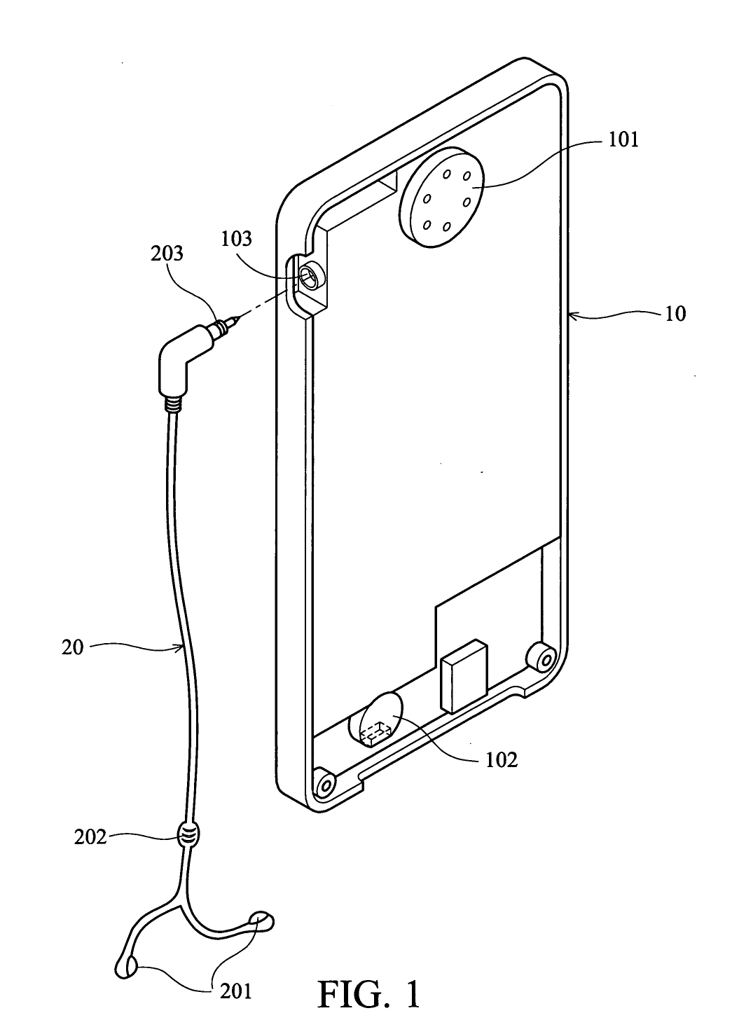

FIG. 2 is perspective diagram of an embodiment of a mobile phone when a hands-free headset and a main body are joined; and

FIG. 3 is a perspective diagram of an embodiment of a mobile phone when a hands-free headset and a main body are separated.

### DETAILED DESCRIPTION

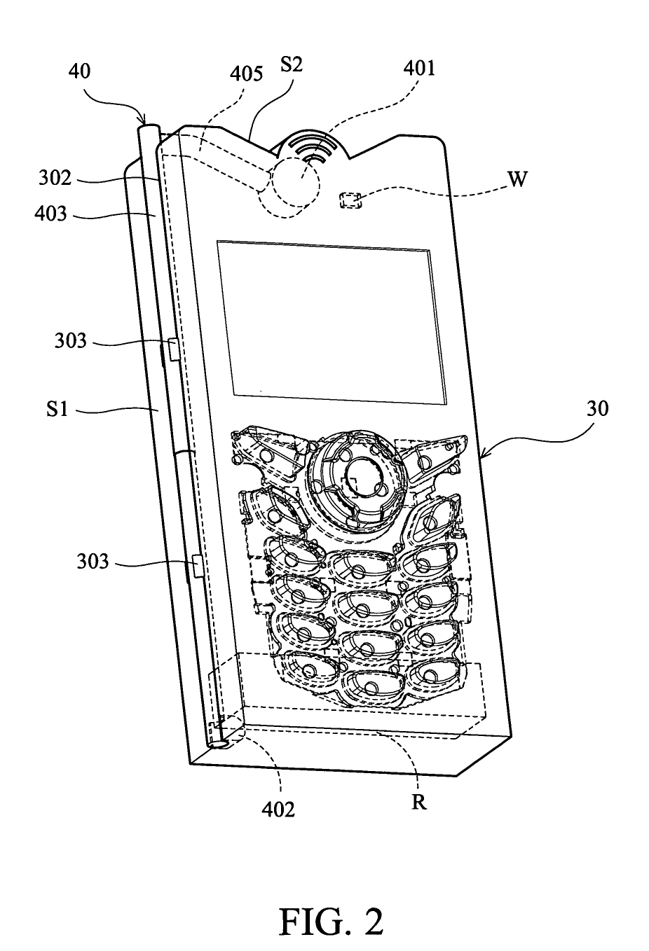

Referring to FIG. 2, an exemplary embodiment of a mobile phone primarily comprises a main body 30 and a hands-free headset 40 detachably joined to the main body 30. When the hands-free headset 40 and the main body 30 are joined, the user can use the mobile phone by manually holding the main body 30. When the hands-free headset 40 separates from the main body 30, the user can talk, merely using the hands-free headset 40 without holding the main body 30.

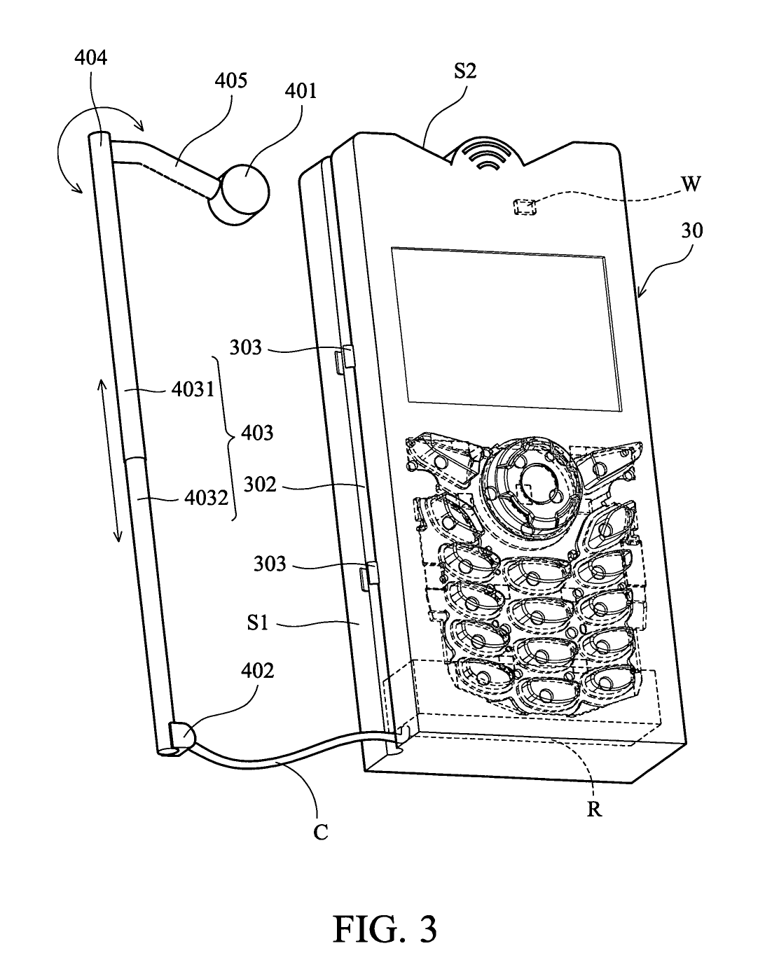

As shown in FIGS. 2 and 3, the hands-free headset 40 primarily comprises a receiver 401, a microphone 402, a hinge 404, a first rod 403 connected to the microphone 402 and a second rod 405 connected to the receiver 401. The first rod 403 comprises a first section 4031 and a second section 4032 retractably connected, such that the user can appropriately adjust the length of the first rod 403. The first and second rods 403 and 405 are pivotally connected via the hinge 404, such that the user can appropriately adjust the angle between the first and second rods 403 and 405.

In FIG. 3, a cable C connects the microphone 402 and the bottom of the main body 30 for electric signal communications between the hands-free headset 40 and the main body 30. When the hands-free headset 40 and the main body 30 are joined, the cable C is accommodated in a receiving space R of the main body 30. In some embodiments, a cable winder (not shown) is provided within the receiving space R, so as to wind the cable C to save space. In some embodiments, the hands-free headset 40 and the main body 30 can communicate with each other by radio signal without the cable C.

Specifically, as shown in FIGS. 2 and 3, the main body 30 further comprises a detector W, such as a tactile switch or other contact switch, to detect whether the hands-free headset 40 and the main body 30 are joined. When the detector W detects the hands-free headset 40 separated from the main body 30, the mobile phone is switched to a hands-free mode, and the receiver 40 serves as an earphone with sound volume appropriately decreased, so as to protect user's hearing.

Alternatively, when the detector W detects that the hands-free headset 40 and the main body 30 are joined, the mobile phone is switched to a hand-held mode. The user can use the mobile phone by holding the main body 30 with the microphone 402 and receiver 401 received therein. Here, since the receiver 401 is received in the main body 30 and distant from the user's ear, sound volume of the receiver 401 is appropriately increased for clear listening.

As shown in FIGS. 2 and 3, the main body 10 has a first side S1 with a recess 302 and a plurality of protruding fixing portions 303 disposed thereon. When the hands-free headset 40 and the main body 30 are joined, the fixing portions 303 clamp the first rod 403 within the recess 302. Moreover, as shown in FIG. 2, the second rod 405 rotates to an angle with respect to the first rod 403, such that the second rod 405 is situated on a second side S2 of the main body 30 with the receiver 401 situated therein. In some embodiments, the fixing portions 403 can be flexible sheets, hooks or buckles firmly securing the hands-free headset 40 and the main body 30.

The hands-free headset 40 can be an in-ear type or over-ear type headphone, such that the users can use the mobile phone for voice communications by manually holding the main body 30 or merely the hands-free headset 40. Since the hands-free headset 40 can both function in hand-held mode and hands-free mode, microphones and receivers built in the main body 30 are not required, thus reducing production costs and saving more space.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation to encompass all such modifications and similar arrangements.

What is claimed is:

1. A mobile phone, comprising:
a main body; and
a hands-free headset detachably connected to the main body, comprising a receiver and a microphone, wherein, when the hands-free headset and the main body are joined, the receiver and the microphone are received in the main body, and the hands-free headset communicates voice signals to the main body via the receiver and the microphone.

2. The mobile phone as claimed in claim 1, further comprising a cable electrically connecting the main body and the hands-free headset.

3. The mobile phone as claimed in claim 1, wherein the main body comprises a receiving space with the cable accommodated therein when the hands-free headset and the main body are joined.

4. The mobile phone as claimed in claim 1, wherein the hands-free headset and the main body communicate with each other by radio signal.

5. The mobile phone as claimed in claim 1, further comprising a detector, wherein output volume of the receiver decreases when the detector detects the hands-free headset separating from the main body.

6. The mobile phone as claimed in claim 5, wherein output volume of the receiver increases when the detector detects that the hands-free headset and the main body are joined.

7. The mobile phone as claimed in claim 5, wherein the detector comprises a tactile switch.

8. The mobile phone as claimed in claim 1, wherein the hands-free headset further comprises a first rod connecting the microphone and a second rod connecting the first rod and the receiver.

9. The mobile phone as claimed in claim 8, further comprising a hinge pivotally connecting the first and second rods.

10. The mobile phone as claimed in claim 8, wherein the first rod comprises a first section and a second section retractably connected to each other.

11. The mobile phone as claimed in claim 8, wherein the main body comprises a first side and a recess disposed on the first side, and the first rod is secured in the recess when the hands-free headset and the main body are joined.

12. The mobile phone as claimed in claim 11, wherein the main body further comprises a second side adjacent to the first side, and the first and second rods form a included angle with the second rod disposed on the second side when the hands-free headset and the main body are joined.

13. The mobile phone as claimed in claim 11, wherein the main body further comprises a fixing portion on the first side to secure the first rod in the recess.

14. The mobile phone as claimed in claim 13, wherein the fixing portion comprises a flexible sheet.
